(19) United States
(12) Patent Application Publication
(10) Pub. No.: US 2017/0157727 A1
(43) Pub. Date: Jun. 8, 2017

(54) DUST COLLECTION ASSEMBLY FOR USE WITH UNIVERSAL DRILL STAND

(71) Applicants: J. Reed Felton, Wauwatosa, WI (US); David J. Buchner, Janesville, WI (US)

(72) Inventors: J. Reed Felton, Wauwatosa, WI (US); David J. Buchner, Janesville, WI (US)

(21) Appl. No.: 15/437,159

(22) Filed: Feb. 20, 2017

Related U.S. Application Data
(63) Continuation-in-part of application No. 14/679,898, filed on Apr. 6, 2015, now Pat. No. 9,586,312.
Application No. 14/679,898 is a continuation-in-part of application No. 13/086,902, filed on Apr. 14, 2011, now abandoned.
(60) Provisional application No. 61/324,630, filed on Apr. 15, 2010.

(51) Int. Cl. B23Q 11/00; B25H 1/00

(52) U.S. Cl. CPC B23Q 11/0046; B23Q 11/0071; B25H 1/0035

(57) ABSTRACT

The present invention is a dust collection assembly for capturing dust, debris and residue that is created during the process of drilling holes into a concrete ceiling. The dust collection assembly is used with a universal drill stand and a drill saddle which has an electric drill secured to it. The drill saddle further comprises a telescoping vacuum tube having a ceiling contact portion that encircles the drill bit at the portion of the drill bit where the drill bit enters the ceiling. As the drill bit begins to penetrate the ceiling, silica dust is generated and removed via the vacuum tube, which tube is connected to a vacuum source.

This application is a continuation-in-part of U.S. patent application Ser. No. 14/679,898 filed Apr. 6, 2015, which is a continuation-in-part of U.S. patent application Ser. No. 13/086,902 filed Apr. 14, 2011, which claims priority to Provisional Application No. 61/324,630 filed on Apr. 15, 2010. The subject matter of each of those applications is incorporated herein by reference.

### FIELD OF THE INVENTION

The present invention relates generally to devices that are used in the field of drills and the process of drilling holes into surfaces. It also relates generally to devices of the type that are used for dust collection. More specifically, the present invention relates to a dust collection assembly that is configured to be used with a drill stand that supports a drill having a drill bit for drilling into overhead ceilings. The drill bit is used for drilling substantially cylindrical holes into ceilings and the dust collection assembly is used in conjunction with the drill and drill bit to collect silica dust, which dust is generated as such holes are drilled into concrete ceilings, in particular.

### BRIEF DESCRIPTION OF THE DRAWINGS

FIG. 1 illustrates a front perspective view of the dust collection assembly of the present invention as used with a universal drill stand.

FIG. 2 is an enlarged and partial cross-sectioned front view of the dust collection assembly of the present invention showing the drill bit prior to penetration into a ceiling.

FIG. 3 is the same view as shown in FIG. 2 but showing the drill bit penetrating into the ceiling.

### GLOSSARY

As used herein, the terms “drill” and “battery drill” mean a power drill operated by use of a DC battery, but could also include a standard corded AC power drill.

As used herein, the term “caster” refers to a wheel or any rotatable component that allows a structure to be moved without lifting.

As used herein, the terms “flat” or “planar” means level, even or without unevenness of surface.

As used herein, the term “selectively” means capable of being attached, detached, or repositioned.

As used herein, the terms “vertical” or “vertically” mean a structure that is in a position or direction that is perpendicular or substantially perpendicular to the plane of the horizon or other horizontal plane.

### BACKGROUND

Before installing fasteners into concrete ceilings, it is necessary to first drill holes. Holes are typically drilled using a hand-held power drill. This repetitive overhead drilling places a great deal of physical strain on a worker because, not only must the worker support the weight of the drill, but apply substantial upward drilling force to the power drill as well.

To reach the overhead surface of a concrete ceiling, the worker must typically construct scaffolding or ascend a ladder or other elevating device to drill each hole. For taller ceilings, a ladder may not reach or because of obstacles may not be able to be placed directly under the surface to be drilled or close enough to the drilling surface, requiring the worker to dangerously overextend in order to drill the hole. In addition, standing on a ladder or other elevating device positions the worker in close proximity to the dust and debris associated with the drilling of overhead concrete or other surfaces.

To avoid these problems It is desirable to have a universal drill stand that is not cumbersome to adjust and such a drill stand is disclosed and claimed in these inventors' U.S. Pat. No. 9,586,312 which will be issued Mar. 7, 207 titled “Universal Drill Stand.” It is also desirable to provide such a drill stand with a power hand tool saddle coupling and saddle base assembly that would be used with the movable universal drill stand for supporting and variably elevating at least one power hand tool proximate to an overhead surface for drilling, nailing or cutting into such surface. Such a saddle coupling is disclosed and claimed in these inventors' U.S. Pat. No. 9,174,337 issued Nov. 3, 205 titled “Saddle Coupling and Saddle Base Assembly for Use With Power Hand Tools.” In the view of these inventors, however, it is also desirable to have a universal drill stand and saddle base assembly that includes a dust collection assembly for capturing dust, debris and residue that is created during the drilling process.

### SUMMARY OF THE INVENTION

The present invention is a dust collection assembly for capturing dust, debris and residue that is created during the drilling process. More specifically, the dust collection assembly is used with a universal drill stand and a drill saddle which has an electric drill secured to it. In the present invention, the drill saddle further comprises a telescoping vacuum tube having a ceiling contact portion that encircles the drill bit at the portion of the drill bit where the drill bit enters the ceiling. As the drill bit begins to penetrate the ceiling, silica dust is generated and removed via the vacuum tube.

The foregoing and other features of the present invention will be apparent from the detailed description that follows.

### DETAILED DESCRIPTION OF INVENTION

For the purpose of promoting an understanding of the present invention, references are made in the text to an exemplary embodiment of a telescoping vacuum tube that is used with a universal drill stand as briefly described above.

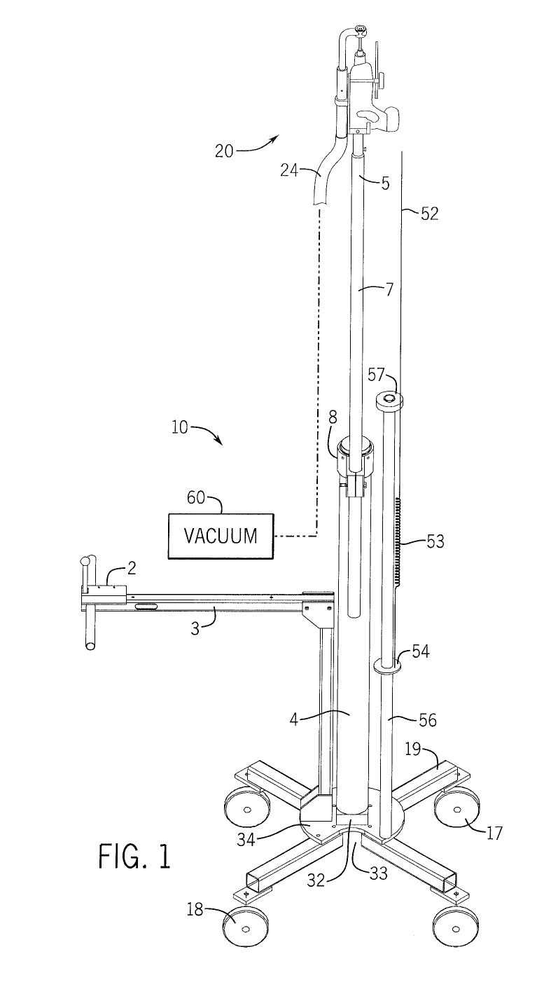

FIG. 1 illustrates an assembled perspective view of a preferred embodiment of the universal drill stand, generally identified 10. The drill stand 10 comprises a planar base plate 34. Extending outwardly from the base plate 34 are a plurality of legs 19. In this embodiment, four legs 19 are shown. At the distal end of each leg is a caster 17, 18. Two of the legs 19 have fixed casters 17 attached to them and two of the legs 19 have rotatable casters 18 attached to them. The rotatable casters 18 are rotatable about a vertical axis such that the casters 18 can turn for maneuvering of the drill stand 10. This configuration allows for easy movement of the drill stand 10 from one location to another and for easy turning and positioning of the stand 10 below a ceiling to be drilled.

Extending upwardly from the base plate 34 is a bottom cap 32, a telescoping or upwardly movable outer tube 4 and a stationary inner tube (not shown). This structure is essentially that of a vertically-oriented wash-down type pneumatic cylinder, the cylinder being powered by compressed air or bottled gases, such as CO₂ or nitrogen. The inner tube, which is essentially the piston rod of the pneumatic cylinder, is coupled to the outer telescoping tube 4.

A control 2 is attached to a handle 3, the handle 3 being that part of the drill stand 10 that is used to move the drill stand 10 and to actuate elevation of the drill saddle and vacuum assembly, generally identified 20 (and also alternatively referred to herein as a “dust collection assembly”). Where a corded drill is used, the control 2 would provide means for powering the drill. A pole clamp offset 8 is provided and an offset tube 7 is secured within the offset 8. A gap 33 in the base plate 34 allows the lower end of the offset tube 7 to be extended downwardly and below the plate 34 as may be required from time to time. This structure is provided in view of the fact that the inner and outer tubes are somewhat limited in their fully-extended height. The offset tube 7 overcomes this limitation. The offset tube 7 is elevated to the desired height and then clamped in position via the pole clamp offset 8. The offset tube 7 comprises an uppermost portion 5, which is preferably configured to be modular such that various attachments can be used with the drill stand 10.

Most significantly, the universal drill stand 10 can elevate drills well beyond the reach of tradesmen. Corded drills can be turned on and off with the switch on the multi-outlet strip or control 2 attached to the handle 3, but this does not allow battery drills to be used. Accordingly, a cable trigger subassembly 50 is provided which is comprised of a cable 52, an extension spring 53, an anchoring washer 54 and a utility pole 56 with a retaining ring 57 with embedded magnets (not shown). The cable 52 whose first end is attached to the saddle and vacuum assembly 20 (or dust collection assembly) in a position to be guided over the drill trigger. The second end of the cable trigger subassembly 50 is attached to the anchoring washer 54 which is slipped over the utility pole 56. Just above the anchoring washer 54 is an extension spring 53. The embedded magnets in the retaining ring 57 allow storage for the anchor washer 54 and for vertical adjustment of the drill stand 10 prior to engaging the cable trigger system. When the drill is extended vertically to within 4-6″ of the ceiling, the anchoring washer 54 is separated from the embedded magnets and allowed to slip down the utility pole 56. When the drill is moved upwardly, the anchor washer 54 binds on the utility pole 56 and tension accumulates on the cable 52. The drill trigger actuates when sufficient cable tension occurs and with the extension spring 53 in the cable linkage allows drill actuation over a practical vertical stroke since the spring stretches as the drill advances vertically. When the drill is reversed in direction, the cable tension is relieved and the drill de-actuates.

Dust control, especially of silica-based dust of the type that is associated with concrete, is becoming an essential safety feature required on job sites. Currently used dust collection constructs use an integrated retractable dust shroud which recedes as the brill bit penetrates the ceiling. Though effective at collecting dust, such constructs have limitations. One such limitation is that accurate placement of the drill bit is obscured by the dust shroud. The saddle and vacuum assembly of the present invention overcomes this limitation and others.

The preferred saddle and vacuum assembly, or dust collection assembly, is generally identified 20. A portion of the assembly 20 cradles an electric drill 50 of conventional manufacture. As will be apparent herein, the saddle and vacuum assembly 20 of the present invention allows for collection of silica dust by using suction from a common shop vacuum, generally identified 60. See FIG. 1. It also allows for use of the assembly 20 with the user being able to visualize the location for the hole that is to be drilled, as will be apparent.

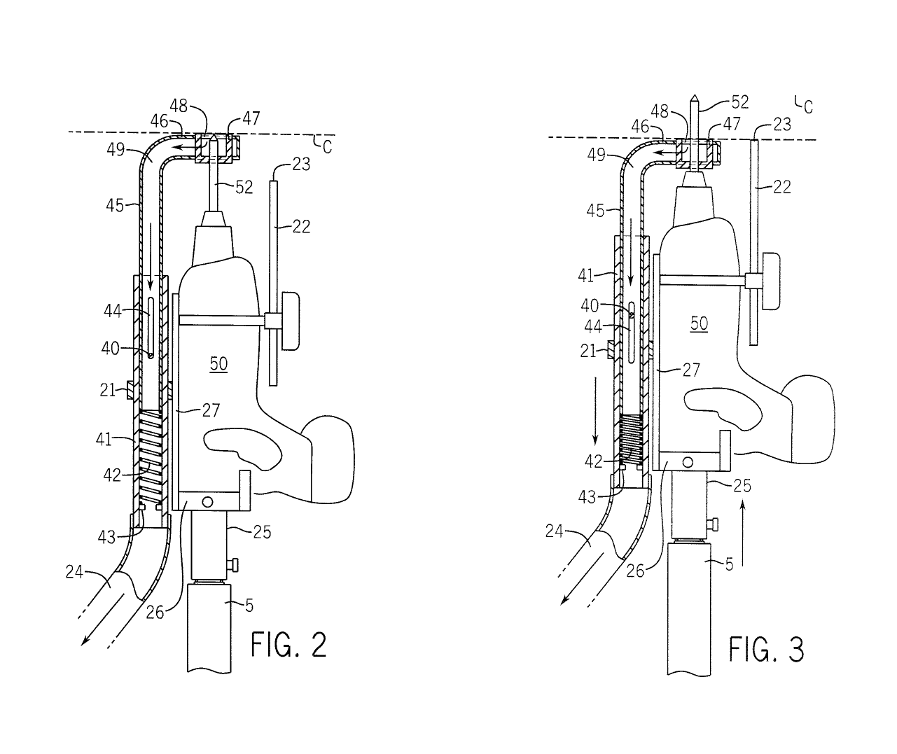

Reference is now made to FIGS. 2 and 3. As shown, the saddle and vacuum assembly 20 of the present invention comprises a modular base 25. The base comprises a bottom support portion 26 and a substantially vertical support portion 27. Together, these portions 26, 27 allow the electric drill 50 to be harnessed in such a way that the drill bit 52 is presented vertically and substantially perpendicularly relative to the ceiling C. Further, a height-limiting structure 22 is incorporated with this assembly 20 such that, when the tip 23 of the height-limiting structure 22 contacts the ceiling C as the drill 50 is elevated, this is an indicator to the user that the required depth of the drilled hole is reached. The assembly 20 can then be lowered to withdraw the drill bit 52 from the ceiling C and the stand 10 can be moved to the next location for a hole to be placed.

The vacuum 60 has a suction hose 24. The dust collection assembly 20 further comprises an attachment collar 21 for securing a hollow outer collection tube 41 in a substantially vertical position. One end of the hose 24 is secured to the bottommost portion of the outer collection tube 41. Disposed within the outer collection tube 41, but also located at or near the bottommost portion of the outer collection tube 41, is a spring-stop portion 43. Disposed above the spring-stop portion 43 is a compression spring 42. Disposed above the compression spring 42 is one end of a hollow inner collection tube 45. The inner diameter of the outer collection tube 41 and the outer diameter of the inner collection tube 45 are dimensioned such that the combination of the tubes 41, 45 allows them to slidably engage one another. The hollow interior 49 of the tubes 41, 45 and the hose 24 provide an air suction continuum between the uppermost portion 46 of the inner tube 45 (in the area where the hole is to be drilled and the vacuum 60. That is, they are telescoping relative to one another with the outer collection tube 41 being stationary and the inner collection tube 45 being vertically movable within the outer collection tube 41. Though disclosed as being round, it is also possible for the shape of the tubes 41, 45 to be configured in shapes other than round—the only structural relation requirement being that the tubes 41, 45 must be telescopically and slidably engageble with one another. For example, a rectangular shape or other shapes are also within the scope of the present invention.

Use of the compression spring 42 within the outer collection tube 41 allows the inner collection tube 45 to be urged upwardly, which is the normal or default position for the inner collection tube 45, as per FIG. 2. Upwardly vertical travel of the inner collection tube 45 is limited via a slot 44 defined within the inner collection tube 45, the slot 44 used in conjunction with a limiting pin 40. See FIG. 2. As shown, the inner collection tube 45 is substantially L-shaped and has a substantially horizontal upper portion 46 that is substantially parallel to the surface of the ceiling C. This right angle tube is laterally adjustable and terminates with a vacuum site tube 47 and dual aperture 48, the aperture 48 being “dual” because it is open at the top and at the bottom. This allows the drill bit 52 to pass through it. This also allows the assembly 20 to compensate for small dimensional differences between various drills. The telescoping tube assembly 41, 45 functions to allow the vacuum site tube 47 to retain ceiling contact for various drilling depths via the spring action of the inner telescoping tube 45 so as to create air flow for the vacuum that effectively “seals” at the ceiling C and allows rapid air movement upward into the downward facing portion of the aperture 48 of the vacuum site tube 47 to prevent dust generated by drilling from falling through the aperture 48. The dual aperture 48 of the vacuum site tube 47 surrounds the drill bit 52 while drilling and simultaneously allows clear site lines to the drilling target on the ceiling C.

As shown in FIG. 2, the position of the component parts of the assembly 20 are illustrated prior to the drill bit 52 penetrating the ceiling C. As the drill 50 is urged upwardly, the vacuum site tube 47 seals about the bit 52 and silica dust and debris is sucked upwardly and inwardly into the inner collection tube 45 and then downwardly into the vacuum hose 24 from the outer collection tube 41. The proper depth of the drilled ceiling hole is reached when the tip 23 of the height-limiting structure 22 contacts the ceiling C. See FIG. 3. During drilling, the vacuum site tube 47 maintains sealing contact with the ceiling C as the inner collection tube 45 moves downwardly, compressing the spring 42. Once drilling is completed, the drill stand 10 and the drill 50 can be conveniently moved to another location to continue the drilling of other holes in the ceiling C.

The details of the invention having been disclosed in accordance with the foregoing, we claim:

1. A dust collection assembly for use with a universal drill stand, the stand for use with a drill and the stand comprising:
a vertical wash-down pneumatic cylinder having an uppermost portion;
a horizontal base for supporting the vertical cylinder;
a pole clamp offset disposed at the uppermost portion of the vertical cylinder;
an offset tube disposed within the pole clamp offset and having an uppermost portion;
a drill saddle disposed at the uppermost portion of the offset tube; and
means for actuating the cylinder to elevate the offset tube and drill saddle for drilling a hole into a concrete ceiling or other overhead surface;
the dust collection assembly comprising:
a substantially vertical outer collection tube, the outer collection tube configured for attachment to the drill saddle;
an inner collection tube, a substantially vertical portion of the inner collection tube disposed within the outer collection tube and a substantially horizontal portion of the inner collection tube configured for parallel placement to a ceiling surface;
a compression spring in the outer collection tube to urge the inner collection tube upwardly;
a vacuum hose connected at a first end to the outer collection tube and at a second end to a vacuum; and
a vacuum site tube and dual aperture structure forming an opening for a drill bit to pass through and forming a vacuum and air passage continuum through the inner collection tube, the outer collection tube, and the vacuum hose.

2. The dust collection assembly of claim 1 wherein the inner collection tube comprises a generally L-shaped structure having a substantially vertical portion and a substantially horizontal portion, the vertical portion being that portion retained within the outer collection tube.

3. The dust collection assembly of claim 1 wherein the inner collection tube comprises a vertical slot and the outer collection tube comprises a pin such that the pin is received within the slot to limit vertical movement of the inner collection tube.

4. The dust collection assembly of claim 1 further comprising a height-limiting structure having a tip that contacts the ceiling when the desired drill depth is reached.

5. A universal drill stand and dust collection assembly for use with a drill having a drill bit, the stand and assembly comprising:
a movable horizontal base;
a vertical inner cylinder secured to the base;
a vertical outer cylinder, the outer cylinder being movable vertically;
an uppermost portion to the outer cylinder;
a pole clamp offset disposed at the uppermost portion of the outer cylinder;
an offset tube disposed within the pole clamp offset and having an uppermost portion;
a drill saddle disposed at the uppermost portion of the offset tube;
means for actuating the outer cylinder to elevate the offset tube and drill saddle for drilling a hole into a concrete ceiling or other overhead surface; and
a dust collection assembly disposed at the drill saddle for evacuating dust as the drill bit drills a hole into the concrete ceiling or other overhead surface.

6. The drill stand and dust collection assembly of claim 5, the dust collection assembly further comprising:
a substantially vertical outer collection tube, the outer collection tube configured for attachment to the drill saddle;
an inner collection tube, a substantially vertical portion of the inner collection tube disposed within the outer collection tube and a substantially horizontal portion of the inner collection tube configured for parallel placement to a ceiling surface;
a compression spring in the outer collection tube to urge the inner collection tube upwardly;
a vacuum hose connected at a first end to the outer collection tube and at a second end to a vacuum; and
a vacuum site tube and dual aperture structure forming an opening for a drill bit to pass through and forming a vacuum and air passage continuum through the inner collection tube, the outer collection tube, and the vacuum hose.

7. The drill stand and dust collection assembly of claim 6 wherein the inner collection tube comprises a generally L-shaped structure having a substantially vertical portion and a substantially horizontal portion, the vertical portion being that portion retained within the outer collection tube.

8. The drill stand and the dust collection assembly of claim 6 wherein the inner collection tube comprises a vertical slot and the outer collection tube comprises a pin such that the pin is received within the slot to limit vertical movement of the inner collection tube.

9. The drill stand and dust collection assembly of claim 6 further comprising a height-limiting structure having a tip that contacts the ceiling when the desired drill depth is reached by the drill bit.
